(19) United States
(12) Patent Application Publication
(10) Pub. No.: US 2008/0054574 A1
(43) Pub. Date: Mar. 6, 2008

(54) Gasket with non-distortable orifice

(76) Inventor: Raymond McGarvey, Columbia, MD (US)

Correspondence Address: VENABLE LLP, P.O. BOX 34385, WASHINGTON, DC, 20043-9998, US

(21) Appl. No.: 11/808,539

(22) Filed: Jun. 11, 2007

Related U.S. Application Data
(60) Provisional application No. 60/812,106, filed on Jun. 9, 2006.

(51) Int. Cl. F16L 17/06

(52) U.S. Cl. 277/608

(57) ABSTRACT

A face seal fitting between two conduits which define an axial flow path is disclosed. The conduits have annular noses projecting from the ends which engage the opposite surfaces of a metal gasket to make engagement. The gasket has a first outer region with surfaces perpendicular to the axial flow path, a second beveled sealing region for engagement with the noses and a third inner region which defines a restrictive orifice.

The Applicant claims the benefit of Application No. 60/812,106.

### BACKGROUND OF THE INVENTION

This invention relates to an improvement in gaskets that have precisely defined central apertures that are used to control, and more particularly restrict, the flow of liquids or gasses through a fitting. There are many applications, particularly in gas systems, where such gaskets having restricted orifices are used to obtain precise flow rates of gases or liquids. These orifices are precisely calibrated to obtain a predetermined flow depending upon the gas or fluid which is being controlled. These orifices are machined into a form which is then used in a particular system such as a pipe or tube fitting wherein the orifice is seated within the conduit.

One application for these orifices is in systems that also use a gasket and polished toroids, also referred to as sealing beads, to obtain a seal. These fittings are commonly referred to as “VCR” fittings and they are very common, particularly in the semiconductor manufacturing industry.

As referred to above, another common application of restricted orifices is in connection with the compressed gas field, which utilizes cylinders and tanks to transport various gases. Some of these applications also rely on a VCR-style seal in connection with the fittings between conduit components.

As explained herein, when the sealing force is applied to prior art gaskets, and more particularly, when the fittings are tightened past “finger tight,” the gaskets tend to deform, which subsequently may distort the size of the restricted opening.

Tests by Omnisafe have shown that the forces acting on gaskets can serve to distort the size of the restricted orifices. As disclosed by Omnisafe, in precise flow applications, often a VCR-type metal seal fitting is be used. During the tightening of these conventional fittings, the defined restrictive orifice which will produce a specified flow, may be distorted, and reportedly reduce the desired flow through the connector. According to published studies including the evaluation of both stainless steel and stainless steel and nickel gaskets, when the fitting was tightened past finger tight the orifice was distorted up to 8.8%. In nickel gaskets, the flow reduced through a restricted orifice was measured at up to 30.5% due to compression of the gasket and torque effects. While the torque effects were identified as a primary cause of the reduction, both torque effects and the distortion of the gasket toward the central flow path caused undesirable flow reduction.

In general VCR fittings use one of three types of gaskets: flat gaskets as depicted in FIG. 2; grooved “CGA” gaskets, which seal on a recessed flat surface—like the standard flat gaskets, see FIGS. 4-7, and grooved gaskets which seal on the angle or angles of the groove. See FIG. 9.

Regardless of which gasket style or material is used, some gasket material is moved within the gasket during assembly of the fitting and this movement causes the gasket to deform. The movement is caused by the forces from the fitting hardware that brings the opposite conduits together. The forces are transmitted from the sealing bead which is on the end of the conduit to the gasket in the form of an arc. For example, see FIG. 8 which depicts VCR bead penetration into a gasket. The material this is displaced by a bead moves within the gasket. In addition, in this fitting the gasket is deformed radially inwardly toward the central axis formed by the conduit and radially outwardly away from the central axis of the conduit.

The area of material movement and the degree to which it moves is dependent upon the gasket material, the contact area and the direction of the gasket, the profile of the sealing bead (typically the bead has a rounded profile) and the amount of force in the assembly process.

In general, flat gaskets have less material movement than grooved gaskets, however, as seen in the test results reported by Omnisafe, even flat gaskets have considerable gasket distortion including the thicker “CGA” gaskets.

In all of these cases the distortion of the orifice is compounded when the gasket is over-tightened during assembly, which may move even more material inward toward the orifice than would happen during correct assembly. As such, the area of the orifice is altered from the desired specification.

The calibrated orifices are carefully machined into the gaskets, which are also used to seal the VCR-style fittings. Although an orifice may be very precisely calibrated and machined for a particular application, the flow rate can be adversely affected by any distortion of the orifice during the assembly of the fitting. If the distortion of the orifice takes place because of the movement of the gasket material during assembly, the calibrated flow rate of the orifice will be thrown off by varying degrees depending upon the amount of distortion.

Accordingly, it is an objection of the present invention to provide a gasket with a restricted orifice that minimizes the deformation upon the assembly.

### SUMMARY OF THE INVENTION

The present invention is directed to a gasket for a fitting between two conduits that also serves as a restrictive orifice within a flow path. The gasket employs beveled surfaces as sealing surfaces which are engaged by opposite sealing beads so that the gasket material is pushed outward and away from an axial flow path of the conduit. Consequently, the size of the restricted orifice is not adversely affected by the distortion of the gasket material caused by the sealing forces. In a preferred embodiment of the invention, the fitting also incorporates an over-tightening prevention feature.

### BRIEF DESCRIPTION OF THE DRAWINGS

FIG. 1. is a sectional view of a conventional prior art restricted orifice shown seated within a conduit.

FIG. 2. depicts a sectional view of conventional prior art VCR style fitting having a flat gasket.

FIG. 3 depicts a sectional view of conventional prior art VCR style fitting using a CGA grooved gasket with a flat sealing surface.

FIG. 4 is a top view of the gasket shown in FIG. 3.

FIG. 5 depicts a sectional view of a prior art flat gasket having recessed sealing surfaces.

FIG. 6 depicts a detailed view of the sealing surfaces of the gasket depicted in FIG. 5.

FIG. 7 depicts a view in perspective of the gasket depicted in FIG. 5.

FIG. 8 is a schematic sectional view of opposite sealing beads engaging a flat gasket.

FIG. 9 depicts a sectional view of a first embodiment of the invention.

FIG. 10 is a sectional view of a second embodiment of the invention

FIG. 11 is a sectional view of the second embodiment with the sealing bead engaged with the sealing surface and inner region of the gasket.

FIG. 12 is a sectional view of an alternative embodiment of a gasket that can be used in accordance with the invention that has a recessed surface and wherein the gasket also defines a restricted orifice.

FIG. 13 is a sectional view of a portion of the gasket depicted FIG. 12.

FIG. 14 is a top plan view of the gasket depicted in FIG. 12.

FIG. 15 is a partial sectional view of a sealing bead from a conduit in engagement with the gasket depicted in FIG. 12.

FIG. 16 is sectional view of another embodiment of the invention that includes an over tightening prevention feature.

FIG. 17 is a sectional view of the embodiment of the invention depicted in FIG. 16 with the flat outer surfaces of the gasket in engagement with a flat surface of the conduit thereby preventing further axial movement of the bead toward the gasket.

### DETAILED DESCRIPTION OF THE INVENTION

Referring now to FIG. 1, a prior art fitting is shown that employs a restricted orifice 103 which serves to regulate the flow of fluids through a fitting. In this fitting, filters 100 and 102 are provided on each side of the restricted orifice 103. The manner in which the fitting provides a seat for the structure that creates the restrictive orifice in the fitting is not disclosed.

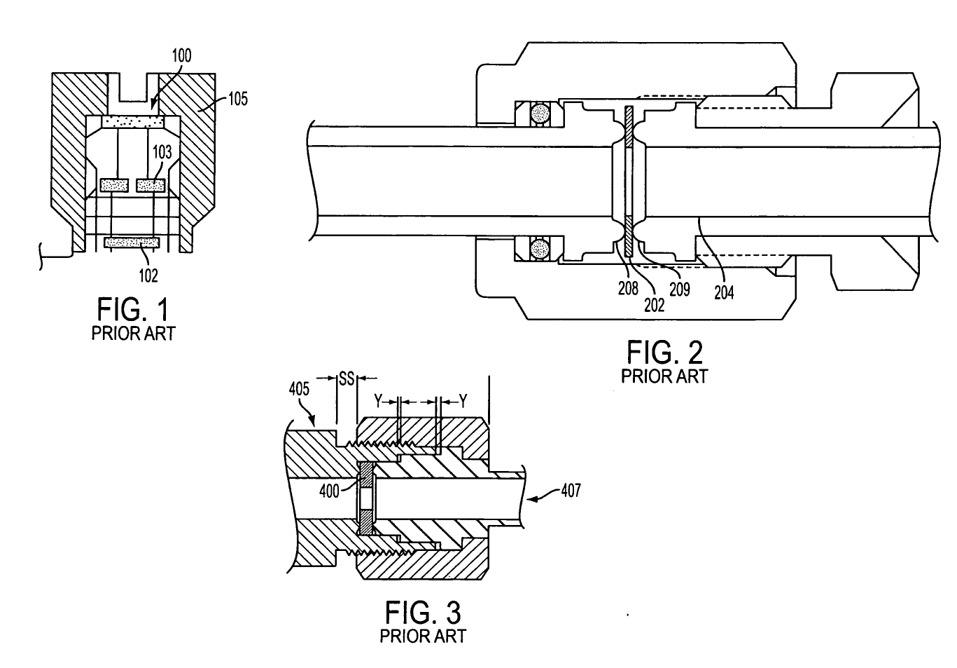

FIG. 2 depicts another prior art flat gasket that is used in a VCR style fitting. In this prior art fitting, gasket 202 is engaged by opposite sealing beads 208 and 209 and does not extend into the flow path and restrict flow.

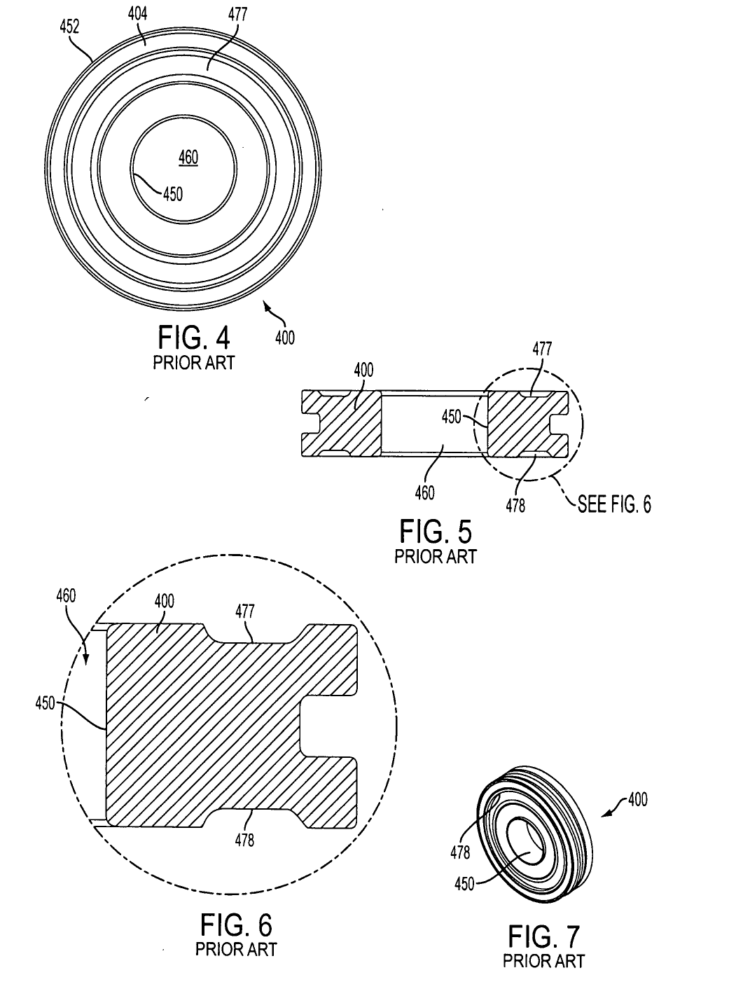

FIG. 3 depicts an alternative prior art gasket that is also used in VCR style fitting 405. In this style of fitting, a flat gasket 400 is employed in a fitting 405 that has a flat recessed surface for engagement of the sealing bead. Here the gasket extends into the flow path 407 and will restrict the flow though the central opening of the gasket. As best seen in FIGS. 5 and 6, recessed flat sealing surfaces 477 and 478 are provided on opposite sides of the gasket. Like conventional flat gaskets, in this type of fitting, the engagement of the sealing beads to the sealing surface causes materials from the gasket to flow both inwardly through as well as outwardly toward the end walls. The flow of material within the gasket as well as the urging of the device toward the central axis can cause distortion of a restrictive orifice. FIG. 4 depicts a top plan view of the gasket illustrated in FIG. 3. Annular gasket 400 is depicted having a top surface 404 and recessed surface 477. Recessed surface 477 is designed to be engaged by the sealing bead. By providing a recessed surface on the gasket the sealing surface may be protected from damages from environmental factors. The seal between a sealing bead and the flat surface on a gasket is depicted in FIG. 6 and is formed in the same respect as a conventional flat gasket such as that disclosed in FIG. 2. The sealing surfaces 477 and 478 are engaged by a sealing bead that forms a seal but causes the gasket to deform. As the gasket deforms in response to pressure from the bead, the gasket material flows both toward outer surface 452 and inner radial surface 450 that defines an interior flow path 460 through the gasket.

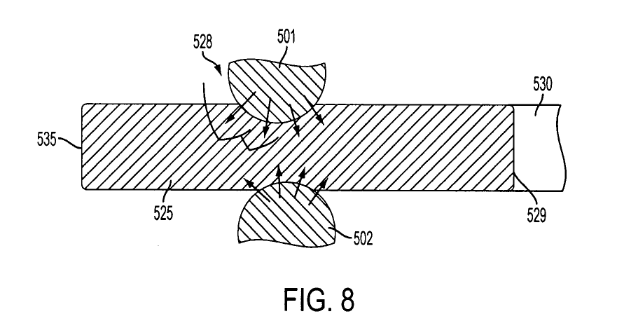

FIG. 8 depicts a sectional view of the sealing beads 501 and 502 coming into contact with gasket material 525 of the prior art. Most of the gaskets in the prior art used for these applications are made of metal such as stainless steel or nickel. The force vectors 528 show that the sealing bead not only exerts a force directly downward or in an axial direction, but also laterally and toward the inner end wall 529 that defines the flow path 530.

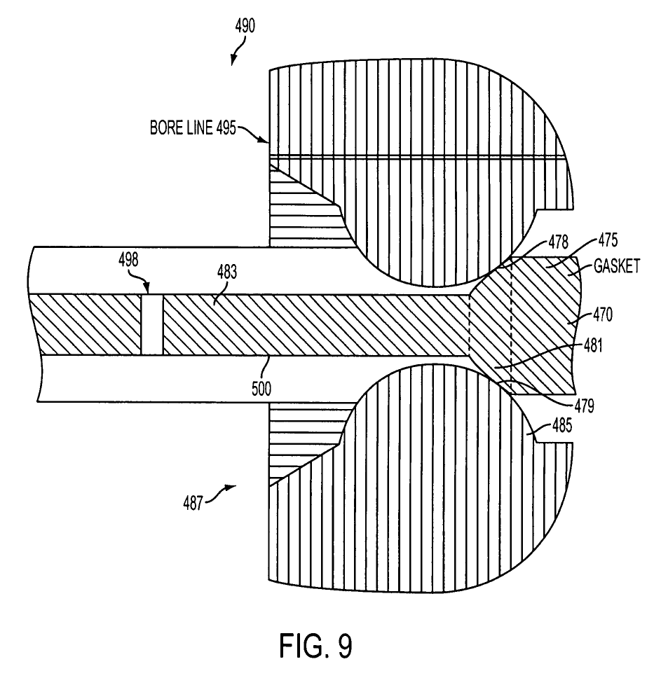

Now referring to FIG. 9, according to the invention, a sealing arrangement is disclosed wherein a gasket 470 is provided in a VCR style fitting that includes a wider thicker first region 475, a transition region 481 having opposite sealing surfaces 478 and 479 and inner region 483. The inner region 483 of gasket 470 extends substantially into the flow path 490 that is defined by the bore line 495 and in the center is provided a restricted orifice 498. In this design, the engagement of the sealing bead 485 with bevel sealing surfaces 478 and 479 does not cause materials from the gasket to flow towards the central flow path and the restrictive orifice but rather, the gasket and material therein are primarily forced outwardly in a radial direction. Sealing bead 485 engages beveled sealing surface 479 to form a seal. This engagement primarily causes gasket material to flow in a radial direction away from the central flow path 490. Consequently, the restricted orifice 498 is not adversely affected by the flow.

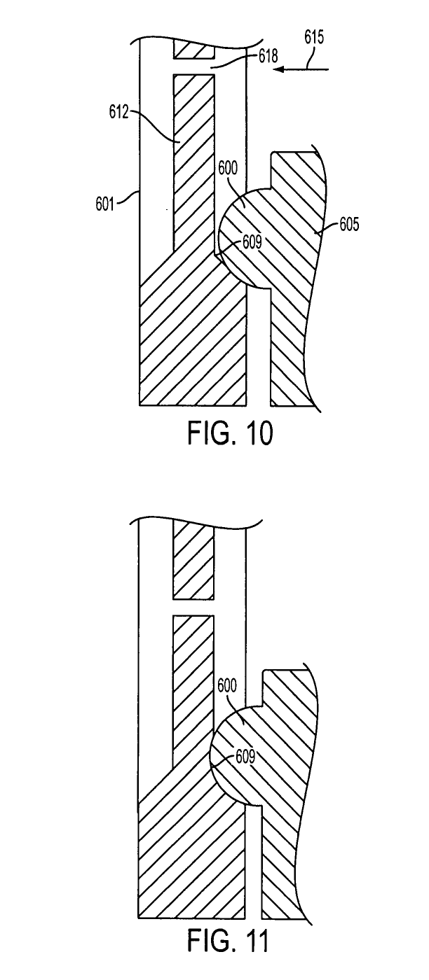

Now referring to FIG. 10, an alternative embodiment of a fitting is depicted showing the engagement of the sealing bead positioned on the end of a gland or conduit 605 in engagement with a gasket with a restricted orifice 601. In this arrangement the sealing bead 485 first contacts the beveled sealing surface 609 of the gasket 600. The inner portion of the gasket 612 extends into the flow path 615 created by the conduit and defines the restrictive orifice 618. FIG. 11 depicts the same fitting as FIG. 10 after the sealing bead 600 has further moved axially into the gasket and causing the sealing surface 609 to deform in response to the pressure exerted upon it by the sealing bead. As the sealing bead further approaches the gasket the top of the bead contacts the inner region of the gasket 612 and effectively stops further axial movement of the bead into the gasket. While the top portion of the sealing bead may exert some sealing force, the distortion is minimized because the primary contact area between bead has formed a long seal surface 609 of the beveled surface.

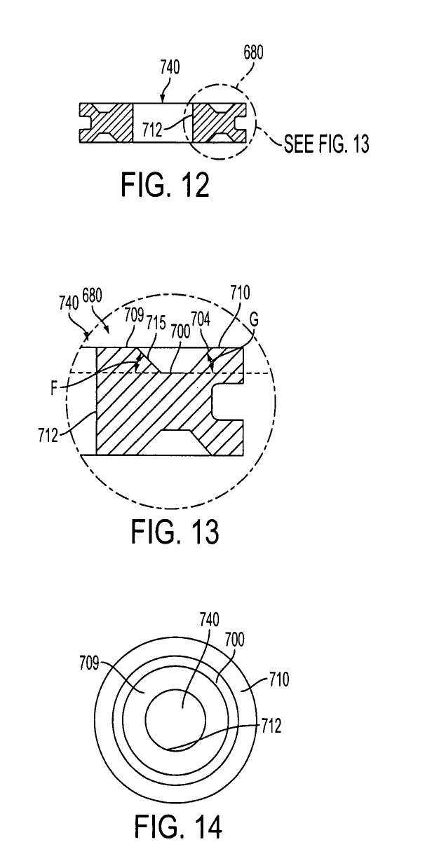

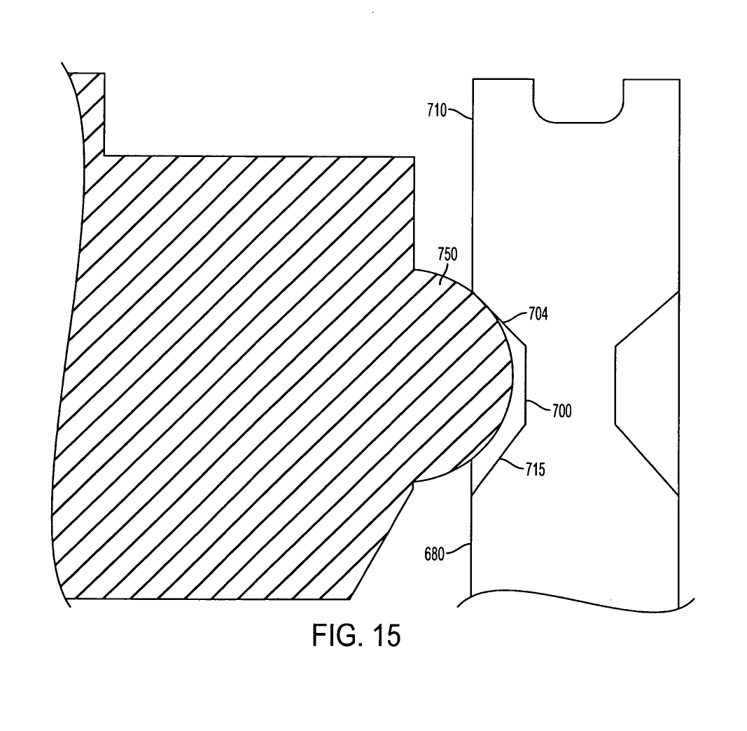

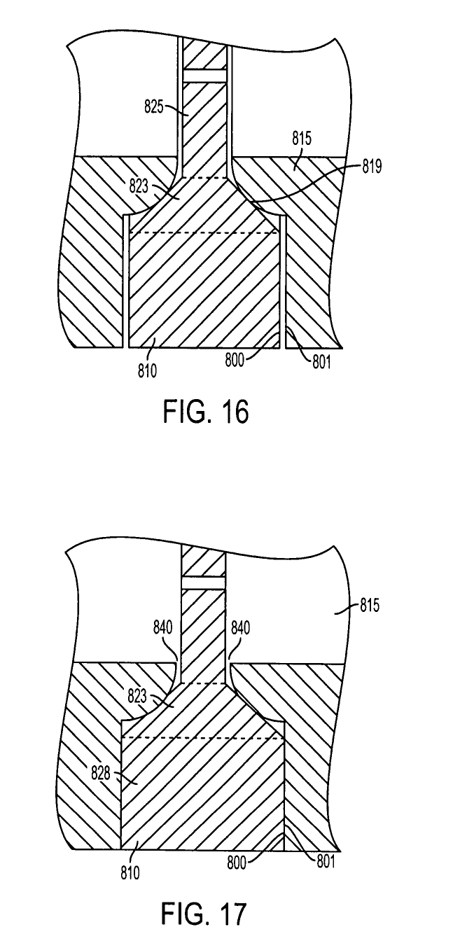

FIG. 12 depicts an alternative design of restrictive orifice gasket 680 wherein the gasket includes two beveled edges, one of which serves as sealing surfaces. An advantage of this design is that the sealing surface and the flat recessed surface are protected from environmental damage. As best seen in FIG. 13, the gasket has a first outer region 710 having opposite flat surfaces. Adjacent to outer region 710 is sealing surface 704 is the sealing surface 704 which extends from the outer region to a flat recessed surface 700. Next, a second beveled surface 715 extends back to an inner surface 709. Lateral surface 712 defines the interior side wall of the conduit. In this embodiment, the inner bevel surface 715 is positioned so that the sealing bead of the VCR-fitting does not come into contact with the surface. This is achieved by making the angle F less than angle G and aligning the sealing bead in a manner in which it is caused to engage the outer beveled sealing surface 704. The engagement of the sealing bead 750 to beveled sealing surface 704 is depicted in FIG. 15. Referring back to FIG. 14, inner sidewall 712 defines the restricted orifice 740 which has a smaller diameter than the diameter of the conduits. Like the previous embodiments this embodiment eliminates or minimizes distortion of the gasket during and after assembly.

Thus an alternative embodiment of the invention uses a grooved gasket design similar to that disclosed by the patent of Aldridge et al., U.S. Pat. No. 5,887,876, but alters the position of the groove so that the sealing bead first contacts the outer beveled surface 704 and then contacts the flat recessed surface 700. The contact with flat recessed surface 700 effectively prevents further axial movement of the sealing bead into the gasket. The inner beveled surface 715 is never contacted by the sealing bead. In contrast to Aldridge, the present invention provides the seals on the outer surface of a two sided grooved gasket as depicted in FIG. 15. This feature, wherein the seal is made on the outer beveled surface of the gasket, can also be incorporated into a “CGA” (Compressed Gas Association) style gasket. By eliminating contact on the inner surface, the material which is on and beyond the inner angle toward the orifice of the gasket is not disturbed during or after assembly. As a result there is no, or at the very least, minimum distortion of the orifice of the gasket though which material will pass.

As shown in FIG. 16, in yet another alternative embodiment of the invention, the improved gasket incorporates a “stop” feature such as that disclosed in the patent to McGarvey U.S. Pat. No. 5,222,747 which is incorporated by reference herein. As shown in FIG. 16 this feature insures that in either a VCR or “CGA” style gasket the forward movement of the bead into the gasket is stopped by contact between outside, thicker region 801 of gasket 810 and a flat end wall section 800 on the portion of the VCR or “CGA” style fitting, which is directly outside of the sealing bead 815. Therefore, in this embodiment, the inner portion of the gasket 825 is never contacted by the sealing bead, even if the fittings are over-tightened. Thus in this fitting, sealing bead 815 contacts sealing surface 819 which is located in medial region 823 of gasket 810 Referring now to FIG. 17, as a result, there will exist a small crevice 840 between the conduit between the end of the sealing bead and the inner region 825 of gasket 810. As with the previous embodiments, the inner region of the gasket is extended into the flow path and defines a precise opening or restricted orifice, the size of which is selected to regulate the flow of liquids or gasses through the conduit.

While the preferred embodiments have been described herein, those skilled in the art will recognize that certain details may be changed without departing from the spirit and scope of the invention. Thus, the foregoing specific embodiments and applications are illustrative only and are not intended to limit the scope of the invention. It is contemplated that the invention will be functional and effective in diverse applications where it is desirable to use a gasket fitting with a restrictive orifice or in any circumstances to securely seat a restrictive orifice.

I claim:

1. A face seal fitting comprising a first conduit having an inner surface defining the outer boundary of a flow path and having a radial end face having an annular nose projecting from said end face,
a second conduit having an inner surface defining the outer boundary of a flow path and a radial end face having an annular nose projecting from said end face, a metal gasket sandwiched between said end faces and making a sealing engagement with said noses,
said gasket having a first outer region with surfaces perpendicular to the axial flow path, a second beveled sealing region for engagement with said noses and a third inner region, said third inner region defining said restrictive orifice,
means to hold said end faces together sandwiching said gasket therebetween with axial pressure applied to said gasket,
said end faces with said noses and said gasket being shaped when fully engaged under axial pressure applied by said means to fit together and form a seal at said beveled sealing surface, and
and wherein the conduits define the outer boundary of a flow path,
wherein, said gasket has an inner region that extends past the sidewalls that define said flow path and said gasket further defines a restricted orifice that restricts flow through said conduit.

2. The device recited in claim 1 wherein said inner region of said gasket has an axial dimension that is smaller than said outer region.

3. The device recited in claim 1 further comprising a recessed surface region, said surface region defining a plane parallel with a plane defined by the radial surface of said outer region and adjacent to said sealing region and, further comprising a second beveled region, said second beveled region connecting said recessed surface to said inner region, and wherein said outer region and said inner region has a substantially similar axial dimension.

4. The device recited in claim 3 wherein an angle formed between the recessed surface and the beveled sealing surface is less than the angle formed between said recessed surface and the second beveled surface.

5. The fitting recited in claim 1 wherein said gasket is annular.

6. A face seal fitting comprising a first conduit having an inner surface defining the outer boundary of a flow path and having a radial end face having an annular rounded sealing bead projecting from said end face,
a second conduit having an inner surface defining the outer boundary of a flow path and a radial end face having an annular rounded sealing projecting from said end face, a metal gasket sandwiched between said end faces and making a sealing engagement with said noses,
said gasket having an inner cylindrical surface having substantially less than the diameter as the inner surfaces of said first and second conduits where said conduits engage said gasket, said inner diameter defining a restricted orifice, and said gasket further comprising a beveled sealing surface, said beveled surface define a face that is angled toward a central axis defined by said conduits,
and means to hold said end faces together sandwiching said gasket therebetween with axial pressure applied to said gasket, said end faces with said noses and said gasket being shaped when fully engaged under axial pressure applied by said means to fit together, wherein said sealing bead engages said gasket and experts a force on said gasket directed away from said central axis.

7. The fitting disclosed in claim 6 further comprising a recessed surface and a second beveled surface defining a fourth region, said fourth region extending from the base of the flat surface region 3 of the gasket to a fourth region and said fourth region is substantially he same axial dimension as said first regions and said fourth region is coplanar with said first region, and said fourth region extends into the flow path and said fourth region defines a restricted orifice, and wherein the angle formed by the beveled edge surface and a line defined by said flat recessed surface is less than the angle formed by said first beveled edge, and wherein when a sealing bead is caused to engage said first angle it will form the seal with said first and not engage said second beveled surface.

8. The fitting disclosed in claim 1 wherein said sealing bead has a rounded profile.

9. The fitting disclosed in claim 1 further comprising means to prevent over tightening.

10. The fitting disclosed in claim 9 wherein said means further comprise providing a flat annular surface on the outer region of said gasket and a flat annular surface on the end of said conduit opposite said outer region of said gasket and wherein the distance said sealing bead extends from said surface is less than the distance between a plane defined by the inner region of said gasket and a plane defined by said outer region of said gasket, wherein said flat surface of said conduit will contact said flat surface of said gasket and prevent the sealing bead from contacting said inner region.
